(19) United States
(12) Patent Application Publication
(10) Pub. No.: US 2024/0107087 A1
(43) Pub. Date: Mar. 28, 2024

(54) SERVER, TERMINAL AND NON-TRANSITORY COMPUTER-READABLE MEDIUM

(71) Applicant: 17LIVE Japan Inc., Tokyo (JP)

(72) Inventors: Yu-Chuan CHANG, Taipei City (TW); Kun-Ze LI, Taipei City (TW); Che-Wei LIU, Taipei City (TW); Chieh-Min CHEN, Taipei City (TW); Kuan-Hung LIU, Taipei City (TW)

(21) Appl. No.: 18/341,428

(22) Filed: Jun. 26, 2023

(30) Foreign Application Priority Data
Sep. 27, 2022 (JP) 2022-153184

(51) Int. Cl. H04N 21/235; H04N 21/2187; H04N 21/84

(52) U.S. Cl. CPC H04N 21/235; H04N 21/2187; H04N 21/84

(57) ABSTRACT

The subject application relates to a server, terminal and non-transitory computer-readable medium. The server for handling streaming data for a live streaming, comprising one or a plurality of processors, wherein the one or plurality of processors execute a machine-readable instruction to perform: recording the streaming data for the live streaming; storing the streaming data as archive contents with first identifier; receiving interaction information during the live streaming; storing the interaction information as contexts with second identifier, transmitting the archive contents with first identifier to a first user terminal; and transmitting the contexts to the first user terminal according to the first identifier and the second identifier. According to the subject application, the archive contents may be more immersive and the user experience may be enhanced.

### CROSS-REFERENCE TO RELATED APPLICATIONS

This application is based on and claims the benefit of priority from Japanese Patent Application Serial No. 2022-153184 (filed on Sep. 27, 2022), the contents of which are hereby incorporated by reference in its entirety.

### TECHNICAL FIELD

This disclosure relates to information and communication technology, and in particular, to a server, terminal and computer program for handling streaming data for a live streaming.

### BACKGROUND

Some APPs or platforms provide archive service for streamers to record their live streaming. The streamers may record their best moments to replay or share with their fans for fun. The viewer may also record the live streaming to recheck the live streaming afterward if they are not available during the live streaming.

While watching the archive video, interaction information such as messages are recommended to be synchronized with the video and displayed on the video in order to have a more immersive experience. Patent Document 1 discloses a method and device for replaying live broadcast, and it synchronizes archive video with effect message according to timeline on the live broadcast.

However, the current archive service still needs more improvements. Therefore, a more efficient and accurate archive service is on demand.
[Patent Document 1]: CN106792219B

### SUMMARY

An embodiment of subject application relates to a server for handling streaming data for a live streaming, comprising one or a plurality of processors, wherein the one or plurality of processors execute a machine-readable instruction to perform: recording the streaming data for the live streaming; storing the streaming data as archive contents with first identifier; receiving interaction information during the live streaming; storing the interaction information as contexts with second identifier, transmitting the archive contents with first identifier to a first user terminal; and transmitting the contexts to the first user terminal according to the first identifier and the second identifier.

Another embodiment of subject application relates to a terminal, comprising one or a plurality of processors, wherein the one or plurality of processors execute a machine-readable instruction to perform: receiving archive contents with first identifier, querying contexts with second identifier from a server according to the first identifier, and rendering the archive contents with the context according to the first identifier and the second identifier.

Another embodiment of subject application relates to a non-transitory computer-readable medium including program instructions, that when executed by one or more processors, cause the one or more processors to execute: recording the streaming data for the live streaming; storing the streaming data as archive contents with first identifier; receiving interaction information during the live streaming; storing the interaction information as contexts with second identifier; transmitting the archive contents with first identifier to a first user terminal; and transmitting the contexts to the first user terminal according to the first identifier and the second identifier.

The present disclosure may archive the live streaming in a more efficient and accurate manner, and the interaction information may be synchronized and displayed in a more accurate manner. Moreover, the modification of the archive contents is more flexible. Therefore, the archive contents may be more immersive and the user experience may be enhanced.

### BRIEF DESCRIPTION OF THE DRAWINGS

FIG. 1 is a schematic configuration of a live streaming system 1 according to some embodiments of subject application;

FIG. 2 is a schematic block diagram of the user terminal 20 according to some embodiments of subject application;

FIG. 3 is a schematic block diagram of the server 10 according to some embodiments of subject application;

FIG. 4 shows an exemplary data structure of the stream DB 320 of FIG. 3;

FIG. 5 shows an exemplary data structure of the archive DB 322 of FIG. 3;

FIG. 6 shows an exemplary data structure of the context DB 324 of FIG. 3;

FIG. 7 is a schematic block diagram of the archive service according to some embodiments of subject application;

FIG. 8 is an exemplary functional configuration of the archive service.

FIG. 9 is an exemplary functional configuration of the archive service.

FIG. 10 is exemplary screen 600 of the archive contents according to some embodiments of subject application;

FIG. 11 is exemplary screen 600 of the archive contents according to some embodiments of subject application;

FIG. 12 is an exemplary sequence chart illustrating an operation of the configuration of the archive service according to some embodiments of subject application.

FIG. 13 is an exemplary flowchart illustrating an operation of the configuration of the archive service according to some embodiments of subject application;

FIG. 14 is an exemplary flowchart illustrating an operation of the configuration of the terminal according to some embodiments of subject application;

FIG. 15 is an exemplary hardware configuration of the information processing device according to some embodiments of subject application.

### DETAILED DESCRIPTION

Hereinafter, the identical or similar components, members, procedures or signals shown in each drawing are referred to with like numerals in all the drawings, and thereby an overlapping description is appropriately omitted. Additionally, a portion of a member which is not important in the explanation of each drawing is omitted.

The live streaming system 1 according to some embodiments of subject application provides enhancement among the users to communicate and interact smoothly. More specifically, it entertains the viewers and streamers in a technical way.

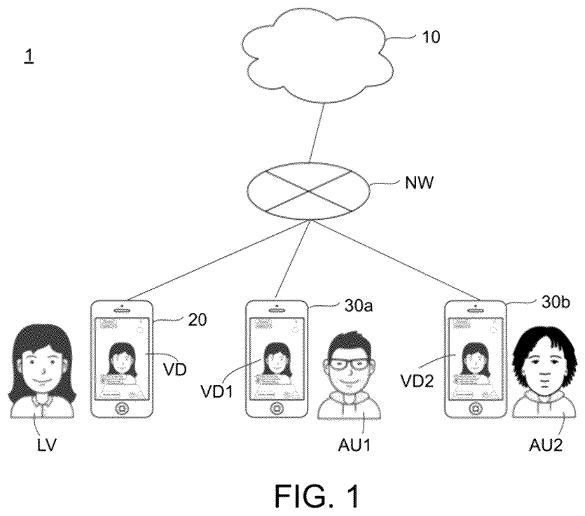

FIG. 1 shows a schematic configuration of a live streaming system 1 according to some embodiments of subject application. The live streaming system 1 provides a live streaming service for the streaming distributor (may also be referred as live or streamer) LV and viewer (may also be referred as audience) AU (AU1, AU2 . . . ) to interact mutually in real time. As shown in FIG. 1, the live streaming system 1 may include a server 10, a user terminal 20 and a user terminal 30(30a, 30b . . . ). The user terminal 20 may be a streamer and the user terminal 30 may be a viewer. In some embodiments, the streamers and viewers may be referred to as the user. The server 10 may include one or a plurality of information processing devices connected via network NW. The user terminal 20 and 30 may be, for example, a portable terminal such as the smartphone, tablet, laptop PC, recorder, mobile game console, wearable device or the like, or the stationary computer such as desktop PC. The server 10, user terminal 20 and user terminal 30 may be communicably connected by any type of wire or wireless network NW.

The live streaming system 1 is involved in the streamer LV, the viewer AU, and APP provider (not shown), who provides the server 10. The streamer LV may record his/her own contents such as songs, talks, performance, game streaming or the like by his/her own user terminal 20 and upload to the server 10, and be the one who distributes contents in real time. In some embodiments, the streamer LV may interact with the viewer AU via the live streaming.

The APP provider may provide a platform for the contents to go on live streaming in the server 10. In some embodiments, the APP provider may be the media or manager to manage the real time communication between the streamer LV and viewer AU. The viewer AU may access the platform by the user terminal 30 to select and watch the contents he/she would like to watch. The viewer AU may perform operations such as commenting or cheering the streamer by the user terminal 30. The streamer, who provides the contents, may respond to the comment or cheer. The response of the streamer may be transmitted to the viewer AU by video and/or audio or the like. Therefore, a mutual communication among the streamer and viewer may be accomplished.

The “live streaming” in this specification may be referred to as the data transmission which enables the contents the streamer LV recorded by the user terminal 20 to be substantially reproduced and watched by the viewer AU via the user terminal 30. In some embodiments, the “live streaming” may also refer to the streaming which is accomplished by the above data transmission. The live streaming may be accomplished by the well-known live streaming technology such as HTTP Live Streaming, Common Media Application Format, Web Real-Time Communications, Real-Time Messaging Protocol. MPEG DASH or the like. The live streaming may further include the embodiment that the viewer AU may reproduce or watch the contents with specific delay while the streamer is recording the contents. Regarding the magnitude of the delay, it should be at least small enough to enable the streamer LV and the viewer AU to communicate. However, live streaming is different from so-called on-demand streaming. More specifically, the on-demand streaming may be referred to as storing all data, which records the contents, in the server and then providing the data from the server to the user at random timing according to the user's request.

The “streaming data” in this specification may be referred to as the data includes image data or voice data. More specifically, the image data (may be referred to as video data) may be generated by the image pickup feature of the user terminal 20 and 30. The voice data (may be referred to as audio data) may be generated by the audio input feature of the user terminal 20 and 30. The streaming data may be reproduced by the user terminal 20 30, so that the contents relating to users may be available for watching. In some embodiments, during the period from the streaming data being generated by the user terminal of the streamer to being reproduced by the user terminal of the viewer, the processing of changing format, size or specification of the data, such as compression, extension, encoding, decoding, transcoding or the like, is predictable. Before and after this kind of processing, the contents (such as video and audio) is substantially unchanged, so it is described in the current embodiments of the present disclosure that the streaming data before being processed is the same as that after being processed. In other words, if the streaming data is generated by the user terminal of the streamer and reproduced by the user terminal of the viewer via the server 10, the streaming data generated by the user terminal of the streamer, the streaming data passed through the server 10 and the streaming data received and reproduced by the by the user terminal of the viewer are all the same streaming data.

As shown in FIG. 1, the streamer LV is providing the live streaming. The user terminal 20 of the streamer generates the streaming data by recording his/her video and/or audio, and transmits to the server 10 via the network NW. At the same time, the user terminal 20 may display the video VD on the display of the user terminal 20 to check the streaming contents of the streamer LV.

The viewer AU1, AU2 of the user terminal 30a, 30b, who request the platform to provide the live streaming of the streamer, may receive streaming data corresponding to the live streaming via the network NW and reproduce the received streaming data to display the video VD1, VD2 on the display and output the audio from a speaker or the like. The video VD1, VD2 displayed on the user terminal 30a, 30b respectively may be substantially the same as the video VD recorded by the user terminal of the streamer LV, and the audio outputted from the terminal 30a, 30b may also be substantially the same as the audio recorded by the user terminal of the streamer LV.

The recording at the user terminal 20 of the streamer may be simultaneous with the reproducing of the streaming data at the user terminal 30a, 30b of the viewer AU1, AU2. If a viewer AU1 inputs a comment on the contents of the streamer LV into the user terminal 30a, the server 10 will display the comment on the user terminal 20 of the streamer in real time, and also display on the user terminal 30a, 30b of the viewer AU1, AU2 respectively. If the streamer LV responds to the comment, the response may be outputted as the text, image, video or audio from the terminal 30a. 30b of the viewer AU1, AU2, so that the communication of the streamer LV and viewer LV may be realized. Therefore, the live streaming system may realize the live streaming of two-way communication.

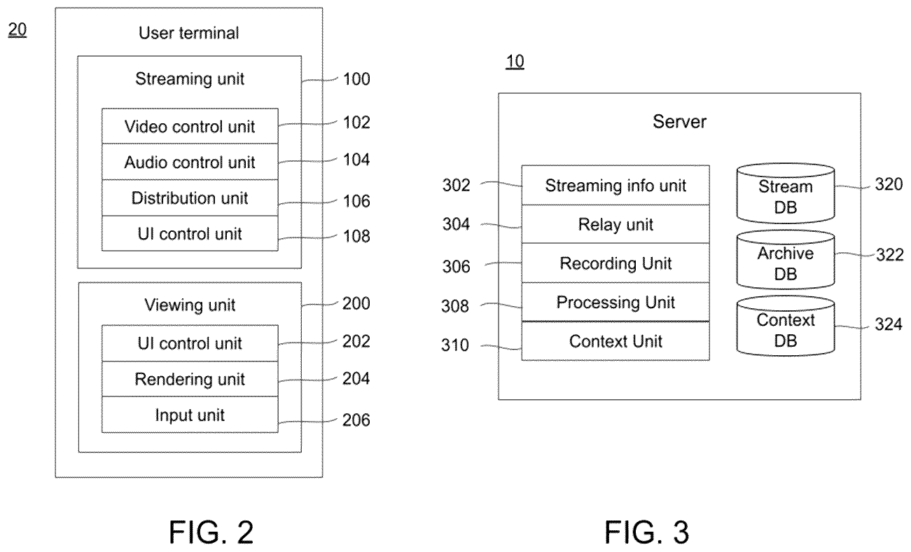

FIG. 2 is a block diagram showing a function and configuration of the user terminal 20 in FIG. 1 according to the embodiment of the present disclosure. The user terminal 30 has the similar function and configuration of the user terminal 20. The blocks depicted in the block diagram of this specification are implemented in hardware such as devices like a CPU of a computer or mechanical components, and in software such as a computer program depicts functional blocks implemented by the cooperation of these elements. Therefore, it will be understood by those skilled in the art that the functional blocks may be implemented in a variety of manners by a combination of hardware and software.

The streamer LV and viewer AU may download and install the live streaming application (live streaming APP) of the present disclosure to the user terminal 20 and 30 from the download site via network NW. Or the live streaming APP may be pre-installed in the user terminal 20 and 30. By the execution of the live streaming by the user terminal 20 and 30, the user terminals 20 and 30 may communicate with the server 10 via the network NW to realize a plurality of functions. The functions realized by the execution of the live streaming APP by the user terminal 20 and 30 (More specifically, the processor such as CPU) is described below as the functions of the user terminal 20 and 30. These functions are basically the functions that the live streaming APP makes the user terminals 20 and 30 realize. In some embodiments, these functions may also be realized by transmitting from the server 10 to the web browser of the user terminal 20 and 30 via network NW and be executed by the computer program of the web browser. The computer program may be written in the programming language such as HTML (Hyper Text Markup Language) or the like.

The user terminal 20 includes streaming unit 100 and viewing unit 200. In some embodiments, the streaming unit 100 is configured to record the audio and/or video data of the user and generate streaming data to transmit to the server 10. The viewing unit 200 is configured to receive and reproduce streaming data from server 10. In some embodiments, a user may activate the streaming unit 100 when broadcasting or activate the viewing unit 200 when watching streaming respectively. In some embodiments, the user terminal who is activating the streaming unit 100 may be referred to as an streamer or be referred to as the user terminal which generates the streaming data. The user terminal who is activating the viewing unit 200 may be referred to as an viewer or be referred to as the user terminal which reproduces the streaming data.

The streaming unit 100 may include video control unit 102, audio control unit 104, distribution unit 106 and UI control unit 108. The video control unit 102 may be connected to a camera (not shown) and the video is controlled by the camera. The video control unit 102 may obtain the video data from the camera. The audio control unit 104 may be connected to a microphone (not shown) and the audio is controlled by the microphone. The audio control unit 104 may obtain the audio data from the microphone.

The distribution unit 106 receives streaming data, which includes video data from the video control unit 102 and audio data from the audio control unit 104, and transmits to the server 10 via network NW. In some embodiments, the distribution unit 106 transmits the streaming data in real-time. In other words, the generation of the streaming data from the video control unit 102 and audio control unit 104, and the distribution of the distribution unit 106 is performed simultaneously.

The UI control unit 108 controls the UI for the streamer. The UI control unit 108 is connected to a display (not shown) and is configured to generate the streaming data to whom the distribution unit 106 transmits, reproduces and displays the streaming data on the display. The UI control unit 108 shows the object for operating or the object for instruction-receiving on the display and is configured to receive the tap input from the streamer.

The viewing unit 200 may include UI control unit 202, rendering unit 204 and input unit 206. The viewing unit 200 is configured to receive streaming data from server 10 via network NW. The UI control unit 202 controls the UI for the viewer. The UI control unit 202 is connected to a display (not shown) and/or speaker (not shown) and is configured to display the video on the display and output the audio from the speaker by reproducing the streaming data. In some embodiments, Outputting the video on the display and audio from the speaker may be referred to as “reproducing the streaming data”.

The UI control unit 202 may be connected to an input unit such as touch panel, keyboard or display or the like to obtain input from the users. The rendering unit 204 may be configured to render the streaming data from the server 10 and the frame image. The frame image may include user interface objects for receiving input from the user, the comments inputted by the viewers and the data received from the server 10. The input unit 206 is configured to receive the user input from the UI control unit 202 and transmit to the server 10 via the network NW.

FIG. 3 is a schematic block diagram of the server 10 according to some embodiments of the subject application. The server 10 may include streaming info unit 302, relay unit 304, recording unit 306, processing unit 308, context unit 310, stream DB 320, archive DB 322 and context DB 324.

The streaming info unit 302 receives the request of live streaming from the user terminal 20 of the streamer via the network NW. Once receiving the request, the streaming info unit 302 registers the information of the live streaming on the stream DB 320. In some embodiments, the information of the live streaming may be the stream ID of the live streaming and/or the streamer ID of the streamer corresponding to the live streaming.

Once receiving the request of providing the information of the live streaming from the viewing unit 200 of the user terminal 30 from the viewer via the network NW, the streaming info unit 302 refers to the stream DB 320 and generates a list of the available live streaming.

The streaming info unit 302 then transmits the list to the user terminal 30 via the network NW. The UI control unit 202 of the user terminal 30 generates a live streaming selection screen according to the list and displays the list on the display of the user terminal 30.

Once the input unit 206 of the user terminal 30 receives the selection of the live streaming from the viewer on the live streaming selection screen, it generates the streaming request including the stream ID of the selected live streaming and transmits to the server 10 via the network. The streaming info unit 302 may start to provide the live streaming, which is specified by the stream ID in the streaming request, to the user terminal 30. The streaming info unit 302 may update the stream DB 320 to add the viewer's viewer ID of the user terminal 30 to the streamer ID of the stream ID.

The relay unit 304 may relay the transmission of the live streaming from the user terminal 20 of the streamer to the user terminal 30 of the viewer in the live streaming started by the streaming info unit 302. The relay unit 304 may receive the signal, which indicates the user input from the viewer, from the input unit 206 while the streaming data is reproducing. The signal indicating the user input may be the object-designated signal which indicates the designation of the object shown on the display of the user terminal 30. The object-designated signal may include the viewer ID of the viewer, the streamer ID of the streamer, who delivers the live streaming the viewer is viewing, and object ID specified by the object. If the object is a gift or the like, the object ID may be the gift ID or the like. Similarly, the relay unit 304 may receive the signal indicating the user input of the streamer, for example the object-designated signal, from the streaming unit 100 of the user terminal 20 while the streaming data is reproducing.

The recording unit 306 may be configured to record the live streaming. In some embodiments, the recording unit 306 may record the live streaming automatically or manually according to the setting by the user terminal 20 of the streamer. For example, the streamer may turn on an auto-archive function before starting live streaming in order to record and archive the live streaming automatically. The recording unit 306 may start recording the live streaming when the streamer starts streaming and stop recording once the live streaming is ended. In some embodiments, the streamer or the viewer may also clip the live streaming manually during the live streaming.

In some embodiments, the recording unit 306 may record the live streaming with a maximum duration of the archive contents, such as eight hours or the like. For example, the recording unit 306 may record the live streaming with a duration up to eight hours or the like. If the live streaming continues for less than eight hours, the recording unit 306 may record and archive the live streaming. However, if the live streaming is longer than eight hours, the recording unit 306 may record the live streaming for eight hours and start another recording for the next eight hours or less.

In some embodiments, the archive contents of the live streaming may be stored in storage such as Google Cloud and register the data of the archive contents in the archive DB 322 for reference and further processing. In some embodiments, any possible transmission protocol such as HTTP live streaming (HLS) may be applied among the server and user terminals. In some embodiments, the recording unit 306 may receive live streaming from a streaming source and record the live streaming as archive contents.

During a live streaming communication, different transmission protocols may be used. Here, HTTP live streaming (HLS) is taken as an example for explanation. HTTP live streaming (HLS) is an HTTP-based streaming media network transmission protocol which is proposed by Apple Inc. The HIS is formed by M3U8 segment index files and transport stream (TS) segments.

The M3U8 file may be referred to as an index file of a ts segment, and may be used for storing download addresses of ts segments in a server. An user terminal can read the ts segments in turn according to the M3U8 file. A ts segment may be referred to as a video clip obtained by dividing an entire video file or a video stream. Each ts segment may include a plurality of frames of video. A ts segment may be around 1-2 seconds or the like. Each ts segment may include one or more GOP (group of picture) structures, which include a plurality of frames of video. A GOP may contain different frame types such as I frame, P frame, B frame or the like. SEI message may be inserted and saved in the I frame.

The HLS may divide an entire audio and video stream into small HTTP-based files for downloading, and only a portion of the files may be downloaded each time. When a media stream is playing, viewers may select to download the same resource at different rates from many different alternate sources, and allow a streaming media session to adapt to different data rates.

Different streaming sources may provide different formats of the streaming data such as FLV or M3U8. The recording unit 306 may receive streaming data from the streaming sources and convert the format of the streaming data into any kind of format for processing. The recording unit 306 may record and store the archive contents as any possible format of streaming data. Here, the M3U8 playlist with the ts segments is taken as an example for explanation. The recording unit 306 may record the streaming data for the live streaming as the ts segments for the processing unit 308 to check and store in a storage.

The processing unit 308 may be configured to process the archive contents. In some embodiments, the processing unit 308 may check and store the archive contents as transport stream (TS) segments. The processing unit 308 may further generate a M3U8 playback list for the TS segments. In some embodiments, the processing unit 308 may keep the archive contents in the storage and database for a specific period such as 7 days, 14 days or the like. Therefore, the memory may be used efficiently.

The context unit 310 may be configured to handle context of interaction information. Here, the context may refer to a rendering context. The context may include interaction information from the viewers. For example, the viewer may send a message or send a gift to the streamer and the context may include the information of the message, gift message, animation, gift animation or the like. The context unit 310 may receive interaction information from the viewers and store the interaction information in the context DB 324. In some embodiments, the context unit 310 may include a plurality of working units for handling contexts from different users.

In some embodiments, the context unit 310 may receive the interaction information from the viewers via a backend server. In some embodiments, the context unit 310 may receive the interaction information from the streamer terminal via a backend server. For example, the streamer may send a message to the viewers or the like. In some embodiments, the context unit 310 may receive the interaction information from the backend server directly. For example, the backend server may send a message to inform that a VIP user is online and join the live streaming, and the context may include the interaction information of the VIP online notification. In some embodiments, the backend server may transmit the interaction information including identifiers such as UTC time information. In some embodiments, the context unit 310 may receive any kind of interaction information such as text, image, animation, notification or the like during the live streaming.

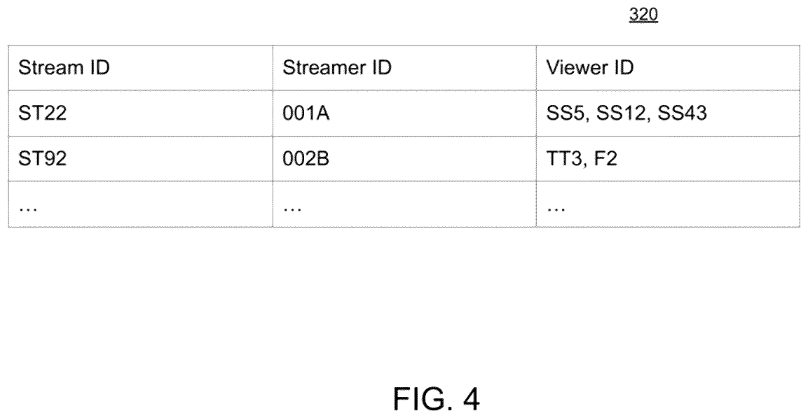

FIG. 4 shows an exemplary data structure of the stream DB 320 of FIG. 3. The stream DB 320 associatively stores the stream ID identifying a live streaming, the streamer ID identifying the streamer conducting the respective live streaming, the viewer ID identifying the viewer viewing the respective live streaming.

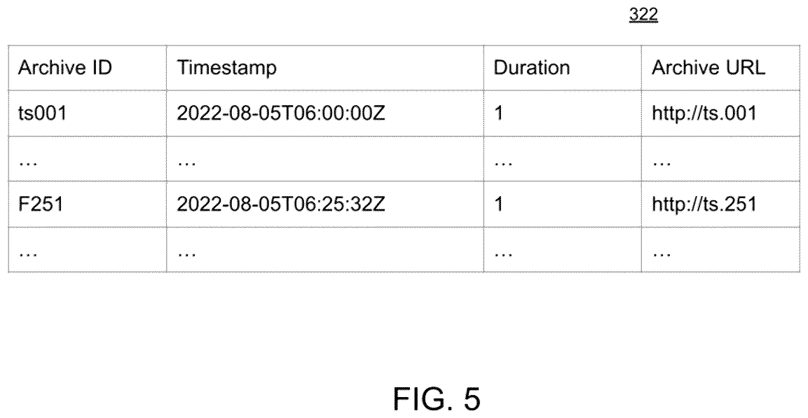

FIG. 5 shows an exemplary data structure of the archive DB 322 of FIG. 3. The archive DB 322 associatively stores the archive ID identifying an archive contents, the timestamp identifying the time information of the archive contents, the duration identifying the duration of the archive contents, the archive URL identifying the location of the archive contents.

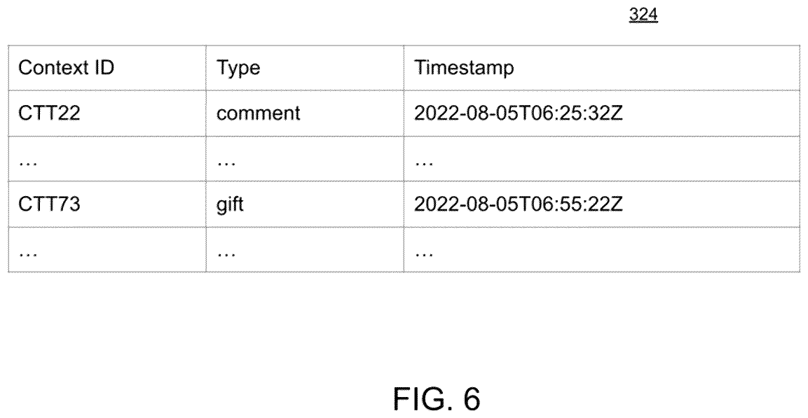

FIG. 6 shows an exemplary data structure of the context DB 324 of FIG. 3. The context DB 324 associatively stores the context ID identifying a context, the type identifying the type of the context and the timestamp identifying the time information of the context.

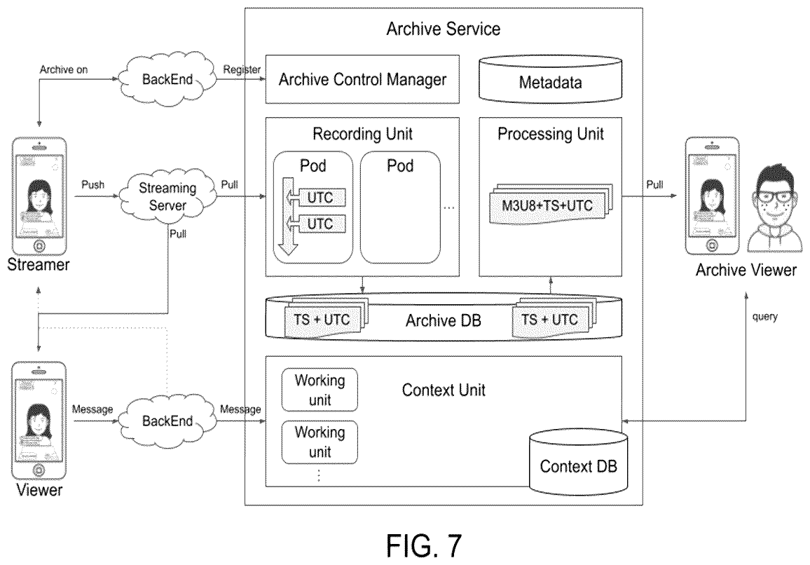

FIG. 7 is a schematic block diagram of the archive service according to some embodiments of subject application. As shown in FIG. 7, the streamer may turn on the archive function in the APP. In some embodiments, the streamer may toggle on the icon of archive function to indicate that the streamer would like to archive the live streaming. The backend may inform the archive control manager to register an archive task for the streamer. In some embodiments, the backend may further inform the streamer that the setup of the archive function was successful by messaging or the like.

The streamer may further start a live streaming by pushing the streaming data to the streaming server. In some embodiments, the streamer may start the live streaming by portable terminal such as smartphone or the like. In some embodiments, the streamer may start the live streaming by software on a computer such as OBS (Open Broadcaster Software). The archive service may be applied to any kind of streaming method from the streamer. The recording unit 306 may pull the live streaming for recording. In some embodiments, the recording unit 306 may insert an identifier in the frame of the archive video while recording the live streaming. For example, the identifier may be inserted in the SEI (Supplemental Enhancement Information) of the frame of the archive video respectively. Therefore, the frame of archive video may include identifier information.

In some embodiments, the duration of the ts segment may be one second and the ts segment may include one GOP structure. One GOP structure may include one I-frame and some P-frame. The I-frame may be the main frame and the P-frame may be the supplementary frame. For example, the I-frame may include the main frame information of the original frame of live streaming, and the P-frame may include some supplementary information such as the difference between the current I-frame and previous I-frame or the like. According to the embodiments, the transmission volume may be reduced.

In some embodiments, one ts segment may include one GOP with one I-frame, which may be used to insert the SEI message with the identifier. In other words, one ts segment may include one identifier such as UTC time information. In some embodiments, one ts segment may include more GOP with more I-frame due to the recording or connection, so one is segment may include more than one UTC time information or the like.

The SEI may be referred to as the text data inserted into the audio and video bitstream to convey extra information. SEI is a standard NAL (Network Abstraction Layer) in the H.264 Video Coding, and it may contain various types of data that describe various properties of the video. SEI messages may also contain arbitrary user-defined data. Moreover, the SEI messages may indicate how the video is recommended to be post-processed or displayed without affecting the core decoding process.

In some embodiments, the identifier may be included in the SEI messages. In some embodiments, the identifier may include an UUID (Universal Unique Identifier) specifically for the archive video. The identifier may be saved in the frame of the archive video. In some embodiments, the identifier may be a unique series of number, letter, text, symbol, combination of above or the like. In some embodiments, the identifier may identify the frame of video or the ts segment of the video from each other. In other words, the identifier for the frame of the video or each ts segment of the video may be unique and different from the others.

In some embodiments, the identifier may be the time information of the frame of the archive video. In some embodiments, the time information may be relative time. For example, the time information may indicate the time length of the frame with respect to the beginning of the archive video, or the time length of the frame with respect to the previous frame of the archive video or the like.

In some embodiments, the time information may also be the absolute time information of the live streaming. For example, the recording unit 306 may save the absolute time of each frame while recording the live streaming as archive video. In some embodiments, the absolute time may be the standard time such as Greenwich Mean Time (GMT). Coordinated Universal Time, the Universal Time Coordinated (UTC) or the like. For example, if a streamer starts a live streaming from 2022-08-05T06:00:00Z to 2022-08-05T07:00:00Z, the recording unit 306 may write the UTC timestamp in the SEI messages for the frame of the archive video and save the SEI messages in corresponding frame of the archive video.

In some embodiments, the identifier may also be a tag which is tagged by the recording unit 306 during recording. For example, the recording unit 306 may also add a tag in a frame of the archive video. The backend server may further send a context with corresponding tag to the context unit 310. Therefore, the context unit 310 may transmit the context with the corresponding tag to the archive viewer when the archive viewers query the context with the tag. In some embodiments, the identifier may also be a unique code to identify the frames of archive contents from each other and connect the frames with corresponding contexts respectively. In some embodiments, the code may be generated by server 10 or another third-party server or the like.

In some embodiments, AI tagging technology may also be applied for inserting tags in each frame of the archive video. Here, the AI tagging may be referred to as the process in which artificial intelligence is used to tag media files with metadata. For example, the recording unit 306 may add a tag automatically with a specific function and the backend server may generate a context with corresponding tag. The AI tagging may detect audio, video, text, image, animation or the like from the streamer or the viewer and generate a tag to be inserted into the corresponding frame of the archive video. For example, the streamer may talk about a car and an AI tag may be inserted during the conversation. The backend server may further generate information such as “car conversation is on-going” or car advertisement video or the like, insert corresponding tag and transmit to the context unit 310. Therefore, the archive video may understand more the topic the streamer was talking about. Moreover, if a viewer does not catch the point of streamer, the viewer may access the archive video with more information displayed on the screen.

In some embodiments, the AI tagging may also be applied according to the location or time information of the streamer or the viewer. For example, if the streamer was broadcasting in a cafe shop, the recording unit 306 may insert a tag to indicate the location of the cafe shop. The archive viewer may receive the information of the cafe shop while checking the archive contents. Moreover, the recording unit 306 may insert a tag periodically such as one hour or the like and generate a context of message with corresponding tag to indicate the time the archive viewer has watched or inform the archive viewer of taking a rest.

In some embodiments, the viewer may pull the live streaming from the streaming server for watching the live streaming. The viewer may interact with the streamer such as commenting, gifting or the like and the interaction information may be transmitted to the streamer or the other viewers via a backend server. In some embodiments, the backend server may further transmit the interaction information to the context unit 310. The context unit 310 may include one or more working units to handle the interaction information. For example, the working unit may write the interaction information into the context DB 324.

In some embodiments, when the backend server transmits the interaction information to the context unit 310, the interaction information may also include an identifier. More specifically, the identifier may be the time information for the backend server to receive the interaction information. In some embodiments, the time information may be relative or absolute such as GMT time, UTC time or the like. For example, the viewer may send a message to the streamer via the backend server and the backend server may save the time information as an identifier in the interaction information. In some embodiments, the context unit 310 may further receive the interaction information with the identifier and write into the context DB 324.

In some embodiments, another viewer user terminal (may be referred to as archive viewer) may request archive contents from the archive service. The processing unit 308 may generate a M3U8 playback list for the ts segments. The M3U8 playback list may include the list of the ts segments and also the identifier information for each frame or ts segment. The identifier information may include, for example, the UTC information for each frame or ts segment respectively.

When the archive viewer replays the archive contents, the archive viewer user terminal may parse the SEI message in the frame of the archive video to obtain the identifier information including the UTC information. In some embodiments, the archive viewer user terminal may further query the context unit 310 about the corresponding context according to the UTC information. In some embodiments, the archive viewer user terminal may query the contexts according to the time point the archive viewer would like to replay. For example, the archive viewer may replay the archive video from the beginning of the archive video or a specific time point of the archive video. The archive viewer user terminal may parse the SEI message in the frame of the archive contents the archive viewer would like to replay and obtain the identifier information. For example, if the archive viewers replay the archive video from the beginning of the archive video and the UTC information is 2022-08-05T06:00:00Z, the archive viewer user terminal may query the contexts with the timestamp of the UTC information.

In some embodiments, the archive viewer may query a specific number of contexts from the time point of the UTC information. For example, the archive viewer user terminal may query 50 contexts or 100 contexts at a time from the time point of the UTC information. In some embodiments, the archive viewer may query a specific time period of contexts from the time point of the UTC information. For example, the archive viewer user terminal may query the contexts in the following 10 minutes or 30 minutes at once from the time point of the UTC information.

In some embodiments, the rendering unit 204 may render the archive contents with the contexts of interaction information according to the identifier information. For example, the rendering unit 204 may render the frame of archive video with the contexts of interaction information according to the UTC information. Therefore, the archive viewer may watch the archive video with all interaction information included. In some embodiments, the interaction information may be the information in a live streaming room except for the video and audio streaming data. For example, the interaction information may be the message of a viewer clicking the like button, or the message that the streamer changed the title of the streaming room. The interaction information may also be the animation such as a viewer obtaining a title, or the animation of a dragon flying across the streaming room or the like.

According to the embodiments, the context unit 310 may receive and transmit any format of interaction information, and just transmit the interaction information to the viewer terminal according to the UTC information. Therefore, any format of interaction information may be displayed and synchronized in the archive contents, and the user experience may be improved.

In some embodiments, even if the archive viewer rewinds or fast forwards the archive video, the archive viewer user terminal may just parse the identifier information and query the context unit 310 about the corresponding context according to the UTC information. Therefore, the archive service may be applied to different scenarios and the flexibility of the archive service may be improved.

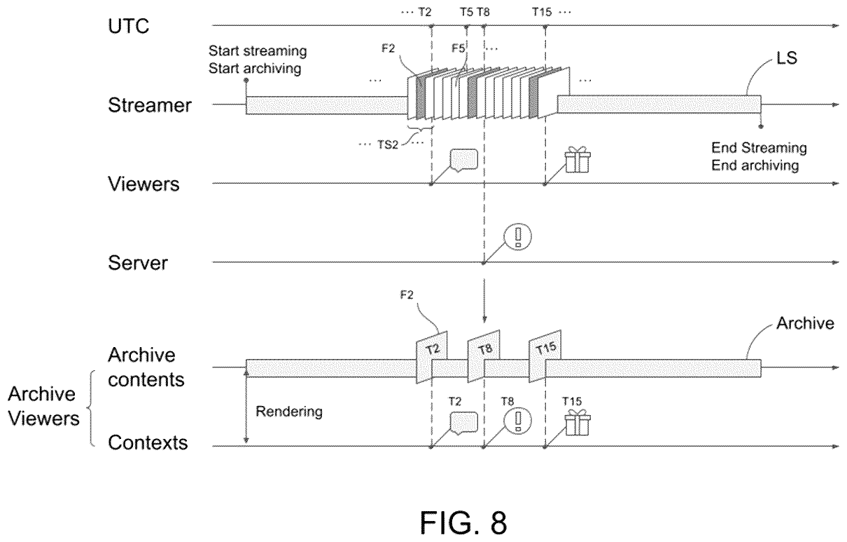

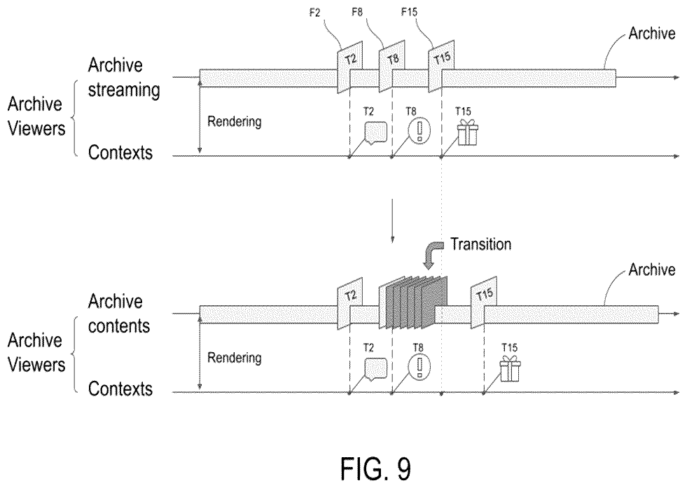

FIG. 8 and FIG. 9 are exemplary functional configurations of the archive service. In FIG. 8 and FIG. 9, the arrow line shows the timeline for the streamer, viewers and the server. The rectangular bar may be referred to as the portions including streaming data such as live streaming or archive video. The rectangular bar may include a plurality of frames or is segments. The viewer may interact with the streamer by sending a message or gift. The streamer may also be the viewer to interact with the other viewers by messaging or the like.

As shown in FIG. 8, the timeline may be corresponding to the UTC time information. The streamer may start streaming and end streaming for a period of time. The recording unit 306 may record the live streaming as archive contents and store the archive video in the archive DB 322. During the recording, the recording unit 306 may record the live streaming as a plurality of ts segments and save the UTC timestamp information to the corresponding frame of the archive video. For example, the UTC timestamp information of the frame F2 may be T2 and UTC timestamp information of the frame F5 may be T5 and so on.

During the live streaming, the viewers may interact with the streamer by messaging, commenting, gifting, following, gaming or the like. For example, the viewer may send a message or gift to the streamer to support the streamer. The viewer may send the interaction information via the backend server and the backend server may transmit the interaction information to the streamer, the other viewers and also the context unit 310. The interaction information may include the time information for the backend server to receive the interaction information. The context unit 310 may further save the interaction information with the time information in the context DB 324. In some embodiments, the time information may also be the UTC timestamp information or the like.

As shown in FIG. 8, the viewer may send a message to the streamer at T2 and send a gift to the streamer at T15. In some embodiments, the server may also send some interaction information to the streamer and viewers automatically to notify specific information such as VIP viewers being online or the like. For example, the server may also send a notification at T8. The context unit 310 may write the interaction information with the time information in the context DB 324.

After the archive contents are published, the archive viewer may check the archive contents, for example, in the streamer's profile page or the like. The archive viewer user terminal may request the archive contents by tapping on the archive contents the archive viewer would like to watch. The processing unit 308 may generate a M3U8 playback list and transmit to the archive viewer user terminal. The M3U8 playback list may include a plurality of ts segments and its corresponding UTC timestamp information.

The archive viewer user terminal may query the context unit 310 about the context of the interaction information according to the UTC timestamp information. The rendering unit 204 in the archive viewer user terminal may further render the archive contents with the interaction information according to the UTC timestamp information. For example, the frame F2 of ts segment TS2 may include the information of UTC timestamp T2. The archive viewer user terminal may query the context unit 310 about the context at T2. The archive viewer user terminal may further render the frame F2 with the context at T2. Therefore, the archive viewer may watch the archive contents in a more immersive manner.

In some embodiments, any kind of interaction information from streamer terminal, viewer terminal or backend server may be queried from the context unit 310 such as messaging, commenting, gifting, following, gaming, VIP online notification or the like. The archive contents may also be rewound or fast forwarded without affecting the rendering of the frames and contexts.

In some embodiments, the processing unit 308 may perform a modification on the archive contents. For example, the processing unit 308 may add a transition segment in the archive contents. More specifically, the processing unit 308 may insert a transition segment in the archive contents, or replace a portion of the archive contents with a transition segment. In some embodiments, the processing unit 308 may delete a portion of the archive contents or the like.

As shown in FIG. 9, a transition segment is added in the archive contents. The transition segment is added after the recording is completed, so the transition segment may not include the UTC timestamp information. Since the transition segment is inserted between the frame F8 and frame F15, the frame F15 may be moved backward. Since the rendering unit 204 is rendering the archive contents according to the UTC timestamp information, the rendering of frame F15 and the context at T15 may not be affected. Therefore, the modification for the archive contents may be more flexible and the rendering accuracy may be improved. Moreover, the duration of the transition segment may be determined flexibly. Even if a portion of the archive contents is replaced or deleted, the rendering unit 204 may render the archive contents in a more accurate manner.

In some embodiments, the transition segment may include text, image, video, audio or the like. In some embodiments, the transition segment may include the information related to the archive contents before or after the transition segment. For example, if the streamer is talking about a car, the transition segment may include information such as advertisements of the car. If the streamer is going to have a performance, the transition segment may include the information of the introduction of the upcoming performance. In some embodiments, the transition segment may include the information related to the archive contents during the transition segment. More specifically, if a portion of the archive contents includes multiple user interaction such as group call or PK mode, the portion of the multiple user interaction may be replaced with a transition segment, and the transition segment may include the information about the portion, such as “group call or PK is on-going” or the like. In some embodiments, the transition segment may include any kind of information to notify the viewer that there is an intermittent or discontinuity in the archive contents. For example, the transition segment may include information such as “a few moments later”, “this portion is omitted” or other related phrases. In some embodiments, the transition segment may include other information such as recommended streamers, advertisements, sales, news, questionnaires or the like. In some embodiments, the transition segment may include information of the streamer such as the introduction of the streamer, live streaming schedule of the streamer or the like.

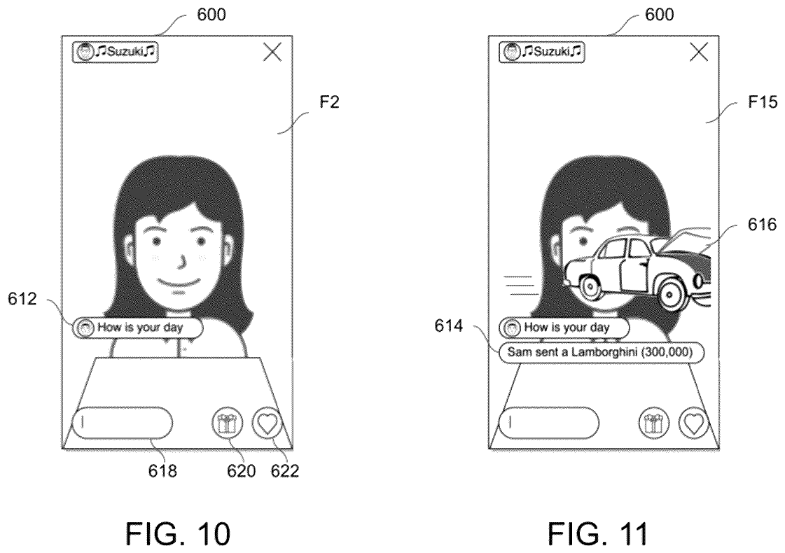

FIG. 10 and FIG. 11 are exemplary screens 600 of the archive contents according to some embodiments of subject application. FIG. 10 shows the archive contents at frame F2 and FIG. 11 shows the archive contents at frame F15. The frame F2 may include the information of UTC timestamp T2 and the frame F15 may include the information of UTC timestamp T15. The archive viewer user terminal may query the context unit 310 about the corresponding context according to the UTC information. An interaction information, such as a message, may be saved with the UTC timestamp T2 and another interaction information, such as a gift, may be saved with the UTC timestamp T15. The archive viewer user terminal may query the contexts of the interaction information. As shown in FIG. 10, an interaction information of message 612 may be rendered with the frame F2 and displayed on the archive viewer user terminal. Moreover, an interaction of gifting information, which including message 614 and animation 616, may be rendered with the is segment TS15 and displayed on the archive viewer user terminal.

In some embodiments, the interaction information may include different information according to the type of the information. For example, the interaction information of messages may include the icon of the user, the contents of the message or the like. The interaction information of gifts may include the message 614 of the gifts, the animation 616 of the gift or the like.

In some embodiments, functions of commenting, gifting, liking, or the like may also be provided while the archive viewer watches the archive contents. For example, the function of commenting, gifting, liking such as icon 618, 620 and 622 in FIG. 10 may also be provided so that the archive viewer may interact with the streamer via the archive contents. In some embodiments, the archive contents may include other functions according to the practice need.

In some embodiments, the interaction information may be rendered on the archive contents. In some embodiments, the interaction information may be rendered separately from the archive contents. In some embodiments, the interaction information may be rendered partially on the archive contents and partially separately from the archive contents. For example, the message 612 may be rendered on the screen 600 as shown in FIG. 10. In some embodiments, the screen 600 may include archive contents zone and message zone (not shown) or the like. The archive contents may be shown on the archive contents zone and the message 612 may be shown on the message zone. In some embodiments, the animation 616 of the gift may be shown on the archive contents zone and the message 614 of the gift may be shown on the message zone. In some embodiments, the layout of the archive contents and interaction information may be determined flexibly.

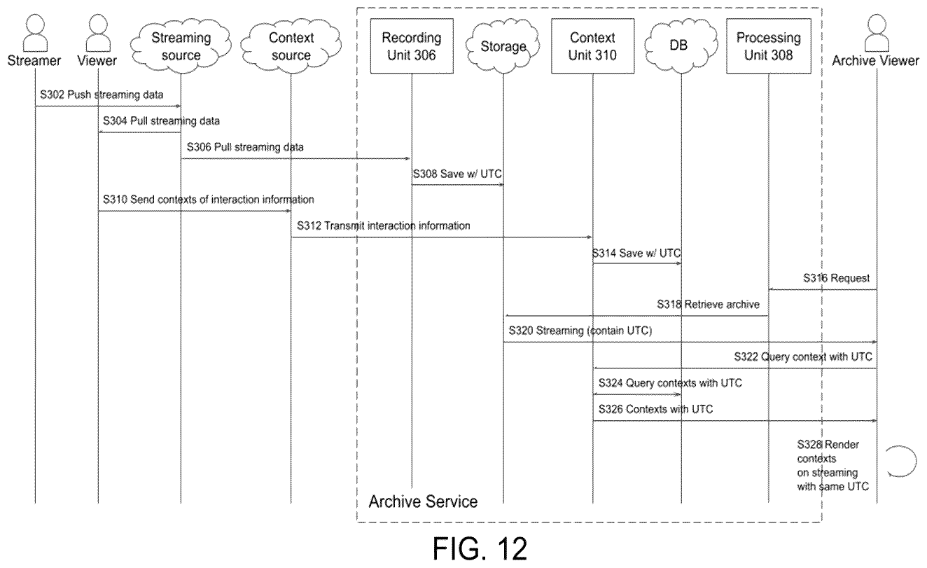

FIG. 12 is an exemplary sequence chart illustrating an operation of the configuration of the archive service according to some embodiments of subject application. In some embodiments, a streamer may start a live streaming by pushing the streaming data to a streaming source (S302). Viewers may pull the streaming data by tapping on the streamer the viewer would like to watch (S304). If the archive function is on, the recording unit 306 may pull the streaming data for recording the live streaming (S306). In some embodiments, the recording unit 306 may record the live streaming as archive contents and save the archive contents with UTC timestamp information (S308).

During the live streaming, the viewers may interact with the streamer by sending interaction information such as comments, gifts, animations or the like (S310). The interaction information may be transmitted to the streamer or the other viewer via a context source such as a backend server in an APP or platform. In some embodiments, the streaming source may be a streaming server and the context source may be a backend server of an APP or platform provider. The context source may transmit the interaction information to the context unit 310 (S312) and the context unit 310 may save the interaction information with the UTC timestamp information in a DB such as the context DB 324 (S314).

After the archive contents are recorded and published, an archive viewer may make a request to watch the archive contents (S316). The processing unit 308 may retrieve the archive contents from the storage (S318) and generate a M3U8 playback list including TS segments and its corresponding UTC timestamp information (S320). When the archive viewer replays the archive contents, the archive viewer user terminal may query the context unit 310 about the contexts of interaction information (S322). The context unit 310 may retrieve the contexts with UTC timestamp information (S324) and transmit to the archive viewer user terminal (S326). The archive viewer user terminal may further render the contexts with the archive contents according to the UTC timestamp information (S328).

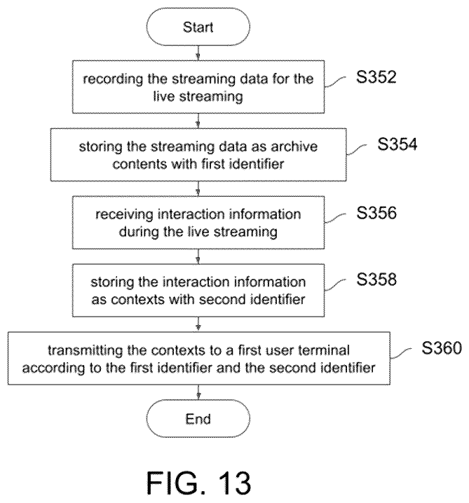

FIG. 13 is an exemplary flowchart illustrating an operation of the configuration of the server 10 according to some embodiments of subject application. As shown in FIG. 13, the recording unit 306 may record the streaming data for the live streaming (S352). The processing unit 308 may store the streaming data as archive contents with first identifier (S354). In some embodiments, the first identifier may be UTC timestamp or the like. The context unit 310 may receive interaction information during the live streaming (S356). The context unit 310 may store the interaction information as contexts with a second identifier (S358). In some embodiments, the second identifier may also be UTC timestamp or the like. In some embodiments, processing unit 308 may transmit the archive contents with the first identifier to a first user terminal in response to a request from the first user terminal. The first user terminal may further query the context unit 310 about the contexts according to the first identifier. The context unit 310 may transmit the contexts to the first user terminal according to the first identifier and the second identifier (S360). According to the embodiments, the archive service may be more efficient and accurate.

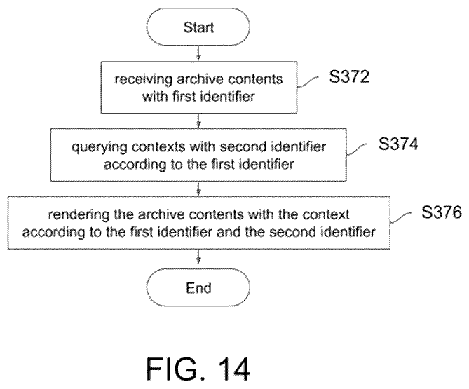

FIG. 14 is an exemplary flowchart illustrating an operation of the configuration of the user terminal 30 according to some embodiments of subject application. As shown in FIG. 14, the rendering unit 204 may receive archive contents with the first identifier (S372). The rendering unit 204 may query contexts with a second identifier according to the first identifier (S374). The rendering unit 204 may further render the archive contents with the contexts according to the first identifier and the second identifier (S376). After the rendering, archive contents with interaction information may be displayed on the archive viewer user terminal. According to the embodiments, the archive viewer may watch the archive contents in a more immersive manner.

There is interaction information such as messages, gifts, animations and so on displayed in the live streaming, and the archive service may synchronize the interaction information with the archive contents. In archive service, archive contents and interaction information are saved and stored separately. During recording, UTC time information is inserted into the SEI message. When there are operations from the user terminal such as messages, gifts or the like, the interaction information according to the operations may also be saved and inserted with the UTC time information. When replaying the archive contents, the SEI messages may be parsed and the UTC time information may be received. The interaction information may be specified according to the UTC time information. The archive viewer user terminal may render and display the interaction information on the screen. Therefore, the archive viewer may have the similar feeling with the viewers who are watching the live streaming.

Moreover, even if transition segments such as ad, interlude animation or the like are inserted, the synchronization of the interaction information with the archive contents may not be affected. The interaction information may be any type of information, for example, the messages, comments, gifts, animation, VIP online notification or the like. In some embodiments, the messages may be messages from the viewers or streamer, and may also be the message from the backend server.

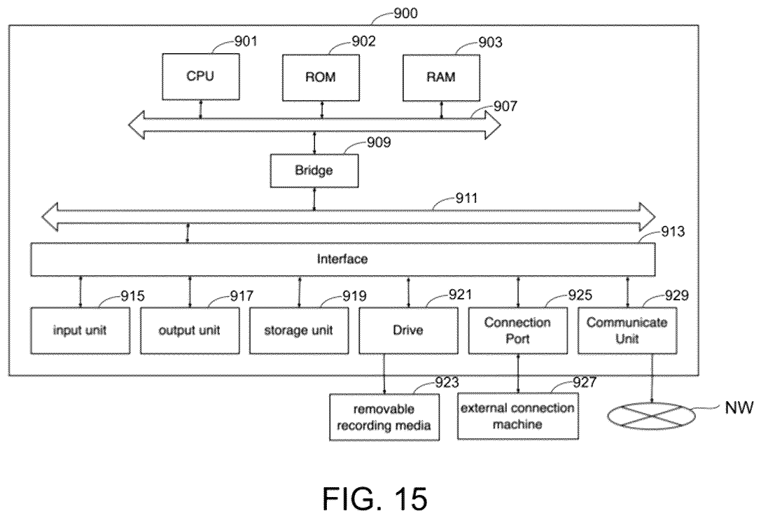

FIG. 15 is a schematic block diagram of computer hardware for carrying out a system configuration and processing according to some embodiments of subject application. The information processing device 900 in FIG. 18 is, for example, is configured to realize the server 10 and the user terminal 20, 30 and the archive service respectively according to some embodiments of subject application.

The information processing device 900 includes a CPU 901, read only memory (ROM) 903, and random-access memory (RAM) 905. In addition, the information processing device 900 may include a host bus 907, a bridge 909, an external bus 911, an interface 913, an input unit 915, an output unit 917, a storage unit 919, a drive 921, a connection port 925, and a communication unit 929. The information processing device 900 may include imaging devices (not shown) such as cameras or the like. The information processing device 900 may include a processing circuit such as a digital signal processor (DSP) or an application-specific integrated circuit (ASIC), instead of or in addition to the CPU 901.

The CPU 901 functions as an arithmetic processing device and a control device, and controls the overall operation or a part of the operation of the information processing device 900 according to various programs recorded in the ROM 903, the RAM 905, the storage unit 919, or a removable recording medium 923. For example, the CPU 901 controls overall operations of respective function units included in the server 10 and the user terminal 20 and 30 of the above-described embodiment. The ROM 903 stores programs, operation parameters, and the like used by the CPU 901. The RAM 905 transiently stores programs used when the CPU 901 is executed, and parameters that change as appropriate when executing such programs. The CPU 901, the ROM 903, and the RAM 905 are connected with each other via the host bus 907 configured from an internal bus such as a CPU bus or the like. The host bus 907 is connected to the external bus 911 such as a Peripheral Component Interconnect/Interface (PCI) bus via the bridge 909.

The input unit 915 is a device operated by a user such as a mouse, a keyboard, a touchscreen, a button, a switch, and a lever. The input unit 915 may be a device that converts physical quantity to electrical signal such as audio sensor (such as microphone or the like), acceleration sensor, tilt sensor, infrared radiation sensor, depth sensor, temperature sensor, humidity sensor or the like. The input unit 915 may be a remote-control device that uses, for example, infrared radiation and another type of radio waves. Alternatively, the input unit 915 may be an external connection device 927 such as a mobile phone that corresponds to an operation of the information processing device 900. The input unit 915 includes an input control circuit that generates input signals on the basis of information which is input by a user to output the generated input signals to the CPU 901. The user inputs various types of data and indicates a processing operation to the information processing device 900 by operating the input unit 915.

The output unit 917 includes a device that can visually or audibly report acquired information to a user. The output unit 917 may be, for example, a display device such as an LCD, a PDP, and an OLED, an audio output device such as a speaker and a headphone, and a printer. The output unit 917 outputs a result obtained through a process performed by the information processing device 900, in the form of text or video such as an image, or sounds such as audio sounds.

The storage unit 919 is a device for data storage that is an example of a storage unit of the information processing device 900. The storage unit 919 includes, for example, a magnetic storage device such as a hard disk drive (HDD), a semiconductor storage device, an optical storage device, or a magneto-optical storage device. The storage unit 919 stores therein the programs and various data executed by the CPU 901, and various data acquired from an outside.

The drive 921 is a reader/writer for the removable recording medium 923 such as a magnetic disk, an optical disc, a magneto-optical disk, and a semiconductor memory, and built in or externally attached to the information processing device 900. The drive 921 reads out information recorded on the mounted removable recording medium 923, and outputs the information to the RAM 905. The drive 921 writes the record into the mounted removable recording medium 923.

The connection port 925 is a port used to directly connect devices to the information processing device 900. The connection port 925 may be a Universal Serial Bus (USB) port, an IEEE1394 port, or a Small Computer System Interface (SCSI) port, for example. The connection port 925 may also be an RS-232C port, an optical audio terminal, a High-Definition Multimedia Interface (HDMI (registered trademark)) port, and so on. The connection of the external connection device 927 to the connection port 925 makes it possible to exchange various kinds of data between the information processing device 900 and the external connection device 927.

The communication unit 929 is a communication interface including, for example, a communication device for connection to a communication network NW. The communication unit 929 may be, for example, a wired or wireless local area network (LAN), Bluetooth®, or a communication card for a wireless USB (WUSB).

The communication unit 929 may also be, for example, a router for optical communication, a router for asymmetric digital subscriber line (ADSL), or a modem for various types of communication. For example, the communication unit 929 transmits and receives signals on the Internet or transmits signals to and receives signals from another communication device by using a predetermined protocol such as TCP/IP. The communication network NW to which the communication unit 929 connects is a network established through wired or wireless connection. The communication network NW is, for example, the Internet, a home LAN, infrared communication, radio wave communication, or satellite communication.

The imaging device (not shown) is a device that images real space using an imaging device such as a charge coupled device (CCD) or a complementary metal oxide semiconductor (CMOS), for example, and various members such as a lens for controlling image formation of a subject image on the imaging device and generates a captured image. The imaging device may capture a still picture or may capture a movie.

The present disclosure of the live streaming system 1 and archive service has been described with reference to embodiments. The above-described embodiments have been described merely for illustrative purposes. Rather, it can be readily conceived by those skilled in the art that various modifications may be made in making various combinations of the above-described components or processes of the embodiments, which are also encompassed in the technical scope of the present disclosure.

The procedures described herein, particularly flowchart or those described with a flowchart, are susceptible of omission of part of the steps constituting the procedure, adding steps not explicitly included in the steps constituting the procedure, and/or reordering the steps. The procedure subjected to such omission, addition, or reordering is also included in the scope of the present disclosure unless diverged from the purport of the present disclosure.

In some embodiments, at least a part of the functions performed by the server 10 or archive service may be performed by other than the server 10 or archive service, for example, being performed by the user terminal 20 or 30. In some embodiments, at least a part of the functions performed by the user terminal 20 or 30 may be performed by other than the user terminal 20 or 30, for example, being performed by the server 10 or archive service. In some embodiments, the rendering of the frame image may be performed by the user terminal of the viewer, the server, the user terminal of the streamer or the like.

Furthermore, the system and method described in the above embodiments may be provided with a computer-readable non-transitory storage device such as a solid state memory device, an optical disk storage device, or a magnetic disk storage device, or a computer program product or the like. Alternatively, the programs may be downloaded from a server via the Internet.

Although technical content and features of the present disclosure are described above, a person having common knowledge in the technical field of the present disclosure may still make many variations and modifications without disobeying the teaching and disclosure of the present disclosure. Therefore, the scope of the present disclosure is not limited to the embodiments that are already disclosed, but includes another variation and modification that do not disobey the present disclosure, and is the scope covered by the following patent application scope.

LIST OF REFERENCE NUMBERS

| | | | |
|---|---|---|---|
| 1 | Live streaming system | 10 | Server |
| 20 | User terminal | 100 | Streaming unit |
| 102 | Video control unit | 104 | Audio control |
| 106 | Distribution unit | | unit |
| 200 | Viewing unit | 108 | UI control unit |
| 204 | Rendering unit | 202 | UI control unit |
| 30, 30a, 30b | User terminal | 206 | Input unit |
| 304 | Relay unit | 302 | Providing unit |
| 308 | Processing unit | 306 | Recording unit |
| 320 | Stream DB | 310 | Context unit |
| 324 | Context DB | 322 | Archive DB |
| 612 | message | 600 | Screen |
| 616 | animation | 614 | message |
| 620 | icon | 618 | icon |
| 900 | Information | 622 | icon |
| | processing device | 901 | CPU |
| 903 | ROM | 905 | RAM |
| 907 | Host bus | 909 | Bridge |
| 911 | External bus | 913 | Interface |
| 915 | Input unit | 917 | Output unit |
| 919 | Storage unit | 921 | Drive |
| 923 | Removable recording | 925 | Connection |
| | medium | | port |
| 927 | External connection device | 929 | Communication |
| LS | Live streaming | | unit |
| NW | Network | LV | Streamer |
| AU1, AU2 | | | Viewer |
| S302, S304 . . . S328 | | | Step |
| VD, VD1, VD2 | | | Video |

What is claimed is:

1. A server for handling streaming data for a live streaming, comprising one or a plurality of processors, wherein the one or plurality of processors execute a machine-readable instruction to perform:
recording the streaming data for the live streaming;
storing the streaming data as archive contents with first identifier;
receiving interaction information during the live streaming;
storing the interaction information as contexts with second identifier;
transmitting the archive contents with first identifier to a first user terminal; and
transmitting the contexts to the first user terminal according to the first identifier and the second identifier.

2. The server for handling streaming data for a live streaming according to claim 1, wherein
the first identifier and second identifier include time information; and
the time information includes standard time of GMT, UTC or the like.

3. The server for handling streaming data for a live streaming according to claim 1, wherein
the first identifier is inserted in a SEI message of a frame of the archive contents; and
the first identifier in one frame of the archive contents is different from the first identifier in another frame of the archive contents.

4. The server for handling streaming data for a live streaming according to claim 1, further comprising
adding a transition segment in the archive contents; wherein
the transition segment includes information related to the archive contents before, during or after the transition segment.

5. The server for handling streaming data for a live streaming according to claim 1, further comprising
transmitting a first number of contexts to the first user terminal; wherein
the first number is calculated according to the first identifier.

6. The server for handling streaming data for a live streaming according to claim 1, wherein
the interaction information is received from a streamer terminal, a viewer terminal, or from the server.

7. The server for handling streaming data for a live streaming according to claim 1, wherein
the interaction information may include messaging, commenting, gifting, following, gaming, VIP online notification or the like.

8. The server for handling streaming data for a live streaming according to claim 1, wherein
transmitting the contexts to the first user terminal is in response to a query from the first user terminal.

9. A terminal, comprising one or a plurality of processors, wherein the one or plurality of processors execute a machine-readable instruction to perform:
receiving archive contents with first identifier;
querying contexts with second identifier from a server according to the first identifier; and
rendering the archive contents with the context according to the first identifier and the second identifier.

10. A non-transitory computer-readable medium including program instructions, that when executed by one or more processors, cause the one or more processors to execute:
recording the streaming data for the live streaming;
storing the streaming data as archive contents with first identifier;
receiving interaction information during the live streaming;
storing the interaction information as contexts with second identifier;
transmitting the archive contents with first identifier to a first user terminal; and
transmitting the contexts to the first user terminal according to the first identifier and the second identifier.
